(19) United States
(12) Patent Application Publication
(10) Pub. No.: US 2009/0309312 A1
(43) Pub. Date: Dec. 17, 2009

(54) PISTON RING FOR THE PISTON OF AN INTERNAL COMBUSTION ENGINE

(76) Inventor: Joao Roberto Mariano, Winterbach (DE)

Correspondence Address: COLLARD & ROE, P.C., 1077 NORTHERN BOULEVARD, ROSLYN, NY, 11576, US

(21) Appl. No.: 12/227,102

(22) PCT Filed: May 9, 2007
(86) PCT No.: PCT/DE2007/000857

§ 371 Date: Feb. 11, 2009

(30) Foreign Application Priority Data
May 10, 2006 (DE) 10 2006 022 027.7

(51) Int. Cl. F16J 9/14

(52) U.S. Cl. 277/497

(57) ABSTRACT

The invention relates to a piston ring (1) for the piston of an internal combustion engine, the ring comprising a ring gap (2) with a respective outer gap region (5, 6) in the vicinity of the upper flank (3) of the piston ring (1), the flank facing the combustion chamber and the lower flank (4) facing away from the combustion chamber, the gap region running perpendicular to the two flanks (3, 4). The ring gap also comprises a central region (7) that interconnects the two outer gap regions (5, 6) and runs obliquely to the flanks (3, 4) of the piston ring (1).

The invention relates to a piston ring for the piston of an internal combustion engine, in accordance with the preamble of the claim.

It is known from the German Patent No. 852 321 to configure the ring joint of a piston ring in such a manner that in the region of the upper wall of the piston ring, facing the combustion chamber, and in the region of the lower wall of the piston ring, facing away from the combustion chamber, an outer ring joint region that lies perpendicular to these walls, in each instance, is disposed, whereby these ring joint regions are connected with one another by way of a central ring joint region that lies parallel to the walls. This has the disadvantage that carbon that collects in the central ring joint region brings about the result that the axial diameter of the piston ring increases, in this region, to such an extent that this region of the piston ring becomes wedged in the ring groove. The lack of free mobility of this piston ring region, however, leads to damage to the inside surface of the cylinder.

Furthermore, a ring joint that reaches from the upper wall, facing the combustion chamber, to the lower all, facing away from the combustion chamber, and disposed at a slant to the walls, is known from the aforementioned patent. It is a disadvantage, in this connection, that acute-angle edges result between the joint ends of the ring joint and a wall of the piston ring, in each instance, which edges can break off, both during ring production and during engine operation, and can cause engine damage.

It is the task of the invention to avoid these disadvantages of the state of the art. This task is accomplished with the characteristics that stand in the characterizing part of the claim.

An exemplary embodiment of the invention will be described below, using the drawings. These show:

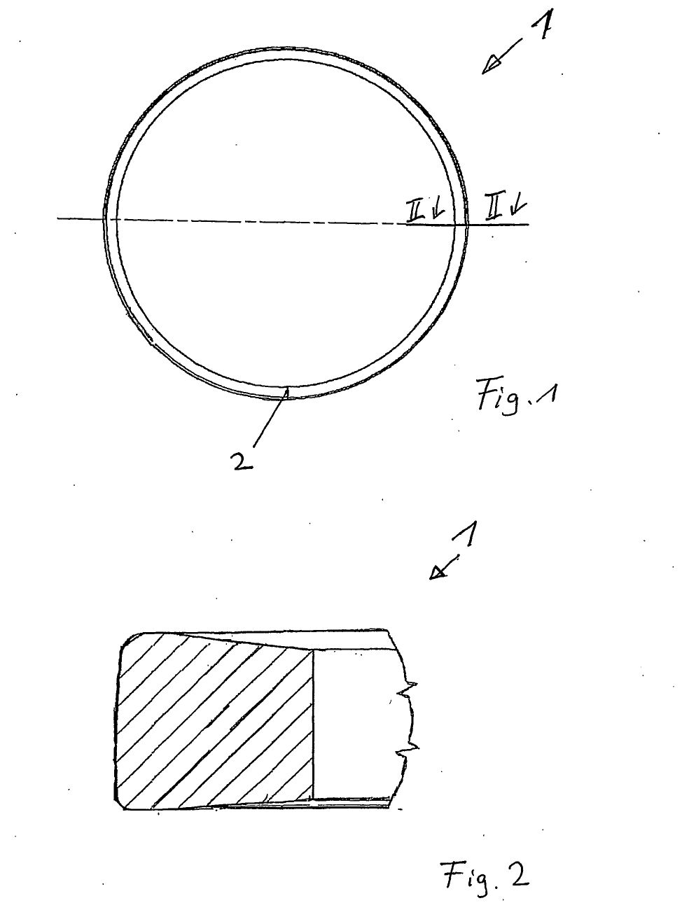

FIG. 1 a piston ring for the piston of an internal combustion engine, in a top view,

FIG. 2 a section through the piston ring along the line II-II in FIG. 1, and

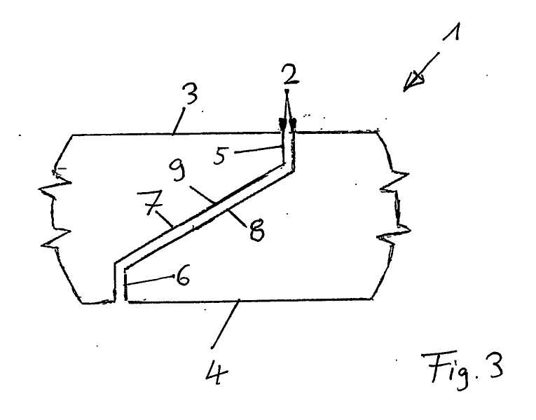

FIG. 3 a side view of the piston ring, to show the ring joint configured according to the invention.

FIG. 1 shows a piston ring 1 according to the invention, for the piston of an internal combustion engine, in a top view, whereby the ring joint 2 of the piston ring 1 can be seen. The piston ring can be produced from gray cast iron, from steel, or from cast iron with spheroidal, graphite.

In FIG. 2, a section through the piston ring 1 along the line II-II in FIG. 1 is shown, which makes it clear that the piston ring 1 is configured as a double-sided trapezoid ring.

The side view of the piston ring 1 according to FIG. 3 shows the configuration of the ring joint 2 according to the invention, which has a joint region 5 and 6, in the region of the upper wall 3 facing the combustion chamber, and in the region of the lower wall 4 of the piston ring 1, facing away from the combustion chamber, that lies perpendicular to these walls 3, 4, in each instance. The length of the two outer joint regions 5 and 6 amounts to approximately ⅕ of the total ring width, and must be dimensioned in such a manner that the central region 7 of the ring joint 2, which connects the two outer joint regions 5 and 6 with one another, is disposed at a slant with reference to the walls 3 and 4 of the piston ring 1.

The ring joint 2 configured according to the invention has the advantage, for one thing, that the two outer joint regions 5 and can be subjected to mechanical stress both during the production of the piston ring 1 and in engine operation. For another thing, carbon is deposited during engine operation, both in the outer joint regions 5 and 6 and in the central region 7 of the ring joint 2, which is comminuted in the central joint region 7, by means of the relative movements of the two ends 8 and 9 of the piston ring 1 that occur during engine operation, and discharged from the ring joint 2 by way of the outer joint regions 5 and 6.

### Reference Symbol List

1 piston ring
2 ring joint
3 upper flank of the piston ring 1, facing the combustion chamber
4 lower flank of the piston ring 1, facing away from the combustion chamber
5, 6 outer joint region
7 central region of the ring joint 2
8, 9 ends of the piston ring 1

1. Piston ring (1) for the piston of an internal combustion engine, having a ring joint (2), wherein the ring joint (2) has an outer joint region (5, 6), in the region of the upper wall (3) facing the combustion chamber, and in the region of the lower wall (4) of the piston ring 1, facing away from the combustion chamber, and that wherein the ring joint (2) has a central region (7), which connects the two outer joint regions (5, 6) with one another, and is disposed at a slant with reference to the walls (3, 4) of the piston ring (1).
